(19) United States
(12) Patent Application Publication
(10) Pub. No.: US 2008/0163737 A1
(43) Pub. Date: Jul. 10, 2008

(54) Guitar pick

(76) Inventor: Adam Grant, Lawndale, CA (US)

Correspondence Address: LAUSON & SCHEWE LLP, 880 APOLLO STREET, SUITE 301, EL SEGUNDO, CA, 90245, US

(21) Appl. No.: 11/651,195

(22) Filed: Jan. 9, 2007

(51) Int. Cl. G10D 3/16

(52) U.S. Cl. 84/320

(57) ABSTRACT

An improved guitar pick is flat metal stock of an oval shape, having a ridge of a rounded cross-section on one side near the leading edge, and preferably decorative and/or informative designs or words permanently imprinted on the top and/or bottom. The metal stock is preferably an alloy of primarily zinc material of about 0.020 inches thick and the ridge thickness a maximum of about 0.014 inches. The guitar pick can be made by deforming a conventional penny into an elongated, and depositing metal material near the leading edge to form the ridge and optionally imprinting the side(s) of the elongated. The penny is preferably deformed to a maximum length of about 1.4 inches and a maximum width of about 0.8 inches.

### BACKGROUND OF THE INVENTION

1. Field of the Invention

This present invention relates generally to guitar picks.

2. Description of the Related Art

Various guitar picks have been around for as long as stringed musical instruments such as guitars, banjos and mandolins, hundreds of years or longer. The word “pick” comes from plectrum or plec for a small piece of plastic, wood, metal or the like for plucking a guitar or other stringed instrument.

Since the late 1800s when celluloid came into being, guitar picks have been commonly been made of various commercial plastics. The most common shape (est. approx. 90% of picks currently being sold) is that of an isosceles triangle with two equal very rounded corners and the third corner rounded to a lesser extent. Other shapes are also known including an equilateral triangle and a more-rounded tear drop shape.

Guitar picks come in varying thicknesses, most commonly about 0.02 inches for thin picks, 0.03 inches for medium picks and 0.04-0.06 inches for heavy picks. Thinner guitar picks are more flexible and tend to offer a wider variety and possibly extreme sounds. Larger and thicker elliptical or wedge-shaped picks are known for bass players for the thicker strings of a bass guitar. Using an ordinary coin for a guitar pick is not popular but known for bass players. To this day musicians search for the optimal material, shape, configuration, etc. for guitar picks to offer new and improved sounds.

In recent years guitar picks have also come in a multitude of colors or background patterns, and with printed indicia thereon such as particular names of bands or performing artists, or manufacturer/company logos. Additionally, artists' signatures, drawings, photos and the like are common guitar pick imprints. Over the years selected guitar picks have become highly collectable, although plastic picks with imprinted designs tend to wear out and the imprinting fades through use and over time.

Elongateds are coins, usually pennies, that have been rolled through steel cast dies, flattening them, and imprinting a new design on one or both sides. Machines exist to squish pennies and add the new designs and are often found at various tourist attractions. Such mutilation of U.S. coins is not unlawful unless done with fraudulent intent to pass off the coins as being other than they are. Such souvenir squished pennies have been popular for years and are also collectable. There is even a Squished Penny Museum in Washington, D.C.

### OBJECTS OF THE INVENTION

It is an object of the present invention to provide an improved guitar pick that will provide unique new and improved sounds;

It is a further object of the present invention to provide a type of guitar pick that will be attractive and collectable; and,

It is still a further object of the present invention to provide a durable guitar pick that can be used and retained for many years.

These and other objects will become apparent upon reading the following detailed description and upon reference to the accompanying drawings.

### BRIEF DESCRIPTION OF THE SEVERAL VIEWS OF THE DRAWINGS

FIG. 1 is a top view of the preferred embodiment of the present invention;

FIG. 2 is a bottom view of the preferred embodiment;

FIG. 3 is a top perspective view of the preferred embodiment; and,

FIG. 4 is a cross-section view of a portion of the preferred embodiment.

### DESCRIPTION OF THE PREFERRED EMBODIMENT

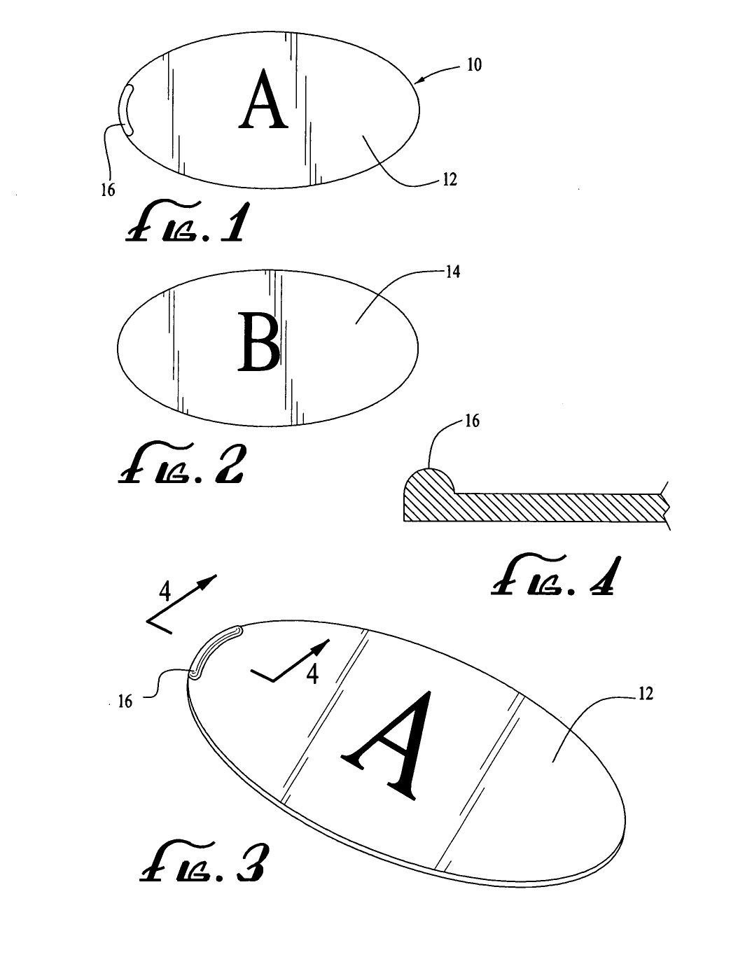

Referring to FIGS. 1-4, the preferred embodiment improved guitar pick 10 may be described. First referring to FIGS. 1, 2, shown is an oval-shaped guitar pick 10 with a length of approximately 1.4 inches and width of approximately 0.8 inches. Preferably the material stock is that of an elongated or smashed penny, a zinc (97.5%) and cooper (2.5%) alloy. The thickness is about 0.020 inches. Optionally, inspirational, decorative or advertising matter A, B may be printed on the top 12 or bottom 14 of the improved pick 10.

As best shown in FIGS. 3, 4, importantly there is a generally semi-circular shaped, hemispherical ridge or lip 12 deposited at the leading edge of the elongated, or very near one of the far ends on one side of the guitar pick 10. The rounded ridge or lip 12 is preferably approximately a maximum 0.014 inches thick at its centerline, making the overall thickness of the improved pick 10 along the middle portion of the ridge or lip 12 approximately 0.034 inches.

The improvement over guitar picks of the prior art is the combination of the shape of the pick, the configuration of the raised ridge, the material of the improved pick and other features and advantages disclosed in this specification. The improved pick with the ridge provides for plucking of the strings of an acoustic or electric guitar rather than merely strumming or brushing the fingers or a pick across the strings. The inventors believe a cleaner and more piercing sound is provided with use of the improved pick. The opposing side of the pick without the ridge may be used for strumming the strings. Also, the pick is bendable enabling one change the angle of attack to accommodate the preferences of the user.

While the present invention has been described with regards to particular embodiments, it is recognized that additional variations of the present invention may be devised without departing from the inventive concept.

What is claimed is:

1. A guitar pick comprising a generally flat metal stock of a generally oval shape, having a ridge of a generally rounded cross-section on one side proximate a leading edge.

2. The guitar pick of claim 1 further comprising indicia permanently marked on at least one side of the guitar pick.

3. The guitar pick of claim 1 wherein the metal stock is primarily zinc material of about a 0.020 inch thickness and is bendable.

4. The guitar pick of claim 3 wherein the ridge has a maximum thickness of about 0.014 inches.

5. The guitar pick of claim 4 wherein the metal stock is a deformed conventional penny having a maximum length of about 1.4 inches and a maximum width of about 0.8 inches.

6. A method of making an improved guitar pick comprising the steps of:
deforming a conventional penny into an elongated; and,
depositing metal material on one side of the elongated proximate a leading edge forming a ridge.

7. The method of claim 6 further comprising the step of permanently imprinting indicia on at least one side of the elongated.

8. The method of claim 6 wherein the penny is deformed to a maximum length of approximately 1.4 inches and a maximum width of approximately 0.8 inches.
